(19) United States
(12) Patent Application Publication
(10) Pub. No.: US 2020/0081861 A1
(43) Pub. Date: Mar. 12, 2020

(54) HIGH SPEED INTERFACE CONNECTION APPARATUS AND METHOD

(71) Applicant: Realtek Semiconductor Corporation, Hsinchu (TW)

(72) Inventors: Chih-Yu HSU, New Taipei (TW); Sung-Kao LIU, Hsinchu (TW); Cheng-Yuan HSIAO, Taichung (TW); Yi-Ting CHIEN, Zhubei City (TW); Wei-Hung CHUANG, Taichung (TW)

(21) Appl. No.: 16/568,505

(22) Filed: Sep. 12, 2019

(30) Foreign Application Priority Data
Sep. 12, 2018 (TW) 107132124

(51) Int. Cl. G06F 13/40; G06F 13/38; G06F 1/3215

(52) U.S. Cl. CPC G06F 13/4068; G06F 13/387; G06F 2213/0026; G06F 2213/0032; G06F 2213/0042; G06F 1/3215

(57) ABSTRACT

A high speed interface connection method used in a high speed interface connection apparatus configured to electrically couple a host terminal having a first connection interface and a device terminal having a second connection interface is provided that includes the steps outlined below. A maximum supported supply power is requested from the host terminal. A dissipated power required by the device terminal in operation is estimated. A host terminal transmission format of the host terminal and a device terminal transmission format of the device terminal in actual operation are respectively determined according to the maximum supported supply power and the dissipated power such that a device dissipated power of the device terminal under actual operation is not larger than a host supply power of the host terminal under actual operation. Communication is performed according to the host terminal transmission format and the device terminal transmission format.

### RELATED APPLICATIONS

This application claims priority to Taiwan Application Serial Number 107132124, filed Sep. 12, 2018, which is herein incorporated by reference.

### BACKGROUND

### Field of Invention

The present invention relates to a high speed interface connection technology. More particularly, the present invention relates to a high speed interface connection apparatus and a high speed interface connection method.

### Description of Related Art

The requirement of the data transmission speed of the electrical devices nowadays is becoming higher. Different types of high speed data transmission connection interfaces are thus developed. A converting device can be used in between electronic devices that have different connection interfaces or protocols, so the electronic devices can perform communication with each other. When a high speed device, such as but not limited to a high speed data storage device, is operating under the highest speed, abnormal operation condition may occur when the power that is required is not fully supplied and thus may result in data loss or device damage. If there is no appropriate mechanism to ensure the normal operation of the high speed device, errors may be generated during the data transmission.

Accordingly, a high speed interface connection apparatus and a high speed interface connection method are required for addressing the issues as mentioned above.

### SUMMARY

An aspect of the present invention is to provide a high speed interface connection method used in a high speed interface connection apparatus configured to electrically couple a host terminal having a first connection interface and a device terminal having a second connection interface. The high speed interface connection method includes the steps outlined below. A maximum supported supplying power is requested from the host terminal. A dissipated power required by the device terminal in operation is estimated. A host terminal transmission format of the host terminal in actual operation and a device terminal transmission format of the device terminal in actual operation are respectively determined according to the maximum supported supplying power and the dissipated power, such that a device terminal dissipated power of the device terminal in actual operation is not larger than a host terminal supplying power of the host terminal in actual operation. Communication is performed by the host terminal and the device terminal respectively according to the host terminal transmission format and the device terminal transmission format.

Another aspect of the present invention is to provide a high speed interface connection apparatus configured to electrically couple a host terminal having a first connection interface and a device terminal having a second connection interface. The high speed interface connection apparatus includes a first port, a second port, a storage and a processing circuit. The first port is configured to electrically couple to and communicate with the first connection interface. The second port is configured to electrically couple to and communicate with the second connection interface. The storage is configured to store a plurality of computer executable commands. The processing circuit is electrically coupled to the first port, the second port and the storage and is configured to retrieve the computer executable commands such that a high speed interface connection method is performed when the processing circuit executes the computer executable commands. The high speed interface connection method includes the steps outlined below. A maximum supported supplying power is requested from the host terminal. A dissipated power required by the device terminal in operation is estimated. A host terminal transmission format of the host terminal in actual operation and a device terminal transmission format of the device terminal in actual operation are respectively determined according to the maximum supported supplying power and the dissipated power, such that a device terminal dissipated power of the device terminal in actual operation is not larger than a host terminal supplying power of the host terminal in actual operation. Communication is performed by the host terminal and the device terminal respectively according to the host terminal transmission format and the device terminal transmission format.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a high speed interface connection apparatus configured to electrically couple a host terminal having a first connection interface and a device terminal having a second connection interface in an embodiment of the present invention; and

FIG. 2 is a flow chart of a high speed interface connection method in an embodiment of the present invention.

### DETAILED DESCRIPTION

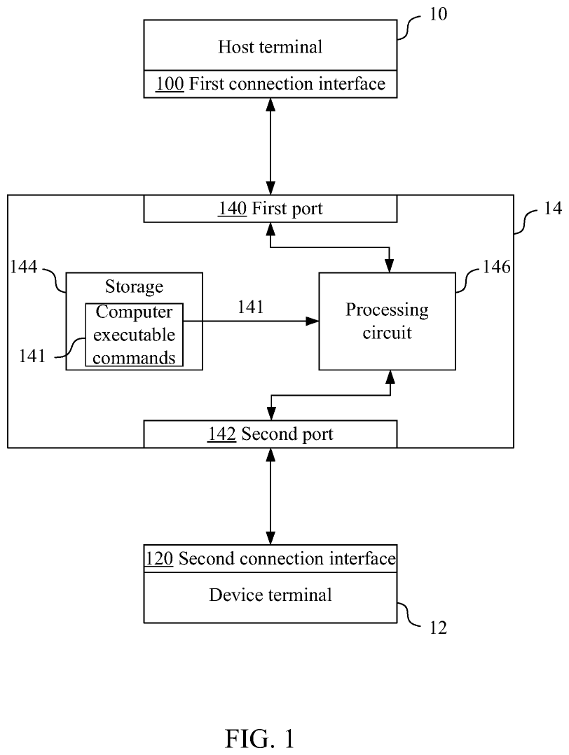

Reference is now made to FIG. 1. FIG. 1 is a block diagram of a high speed interface connection apparatus 14 configured to electrically couple a host terminal 10 having a first connection interface and a device terminal 12 having a second connection interface in an embodiment of the present invention.

In an embodiment, the host terminal 10 can be such as, but not limited to a desktop computer, a notebook computer or a handheld electronic device such as a smartphone. The device terminal 12 can be such as, but not limited to a data storage device.

In an embodiment, the host terminal 10 has a first connection interface 100, and the device terminal 12 has a second connection interface 120. The first connection interface 100 can be such as, but not limited to universal serial bus (USB). The second connection interface 120 can be such as, but not limited to serial advanced technology attachment (SATA) or Peripheral Component Interconnect Express (PCIE).

The high speed interface connection apparatus 14 operates as an adapter between the host terminal 10 and the device terminal 12 having different connection interfaces. More specifically, the high speed interface connection apparatus 14 electrically couples the host terminal 10 having the first connection interface and the device terminal 12 having the second connection interface. The high speed interface connection apparatus 14 further allows the host terminal 10 and the device terminal 12 to communicate with each other through the high speed interface connection apparatus 14.

The high speed interface connection apparatus 14 includes a first port 140, a second port 142, a storage 144 and a processing circuit 146.

The first port 140 is configured to electrically couple to and communicate with the first connection interface 100. The second port 142 is configured to electrically couple to and communicate with the second connection interface 120.

In an embodiment, the storage 144 can be such as, but not limited to a random access memory (RAM) or a read only memory (ROM). The storage module 144 is configured to store a plurality of computer executable commands 141.

The processing circuit 146 is electrically coupled to the first port 140, the second port 142 and the storage 144. In an embodiment, the processing circuit 146 is configured to retrieve the computer executable commands 141 such that the processing circuit 146 executes the computer executable commands 141 to operation the function of the high speed interface connection apparatus 14. More specifically, by executing the computer executable commands 141, the processing circuit 146 allows the host terminal 10 and the device terminal 14 performing communication with the most suitable transmission formats through the high speed interface connection apparatus 14.

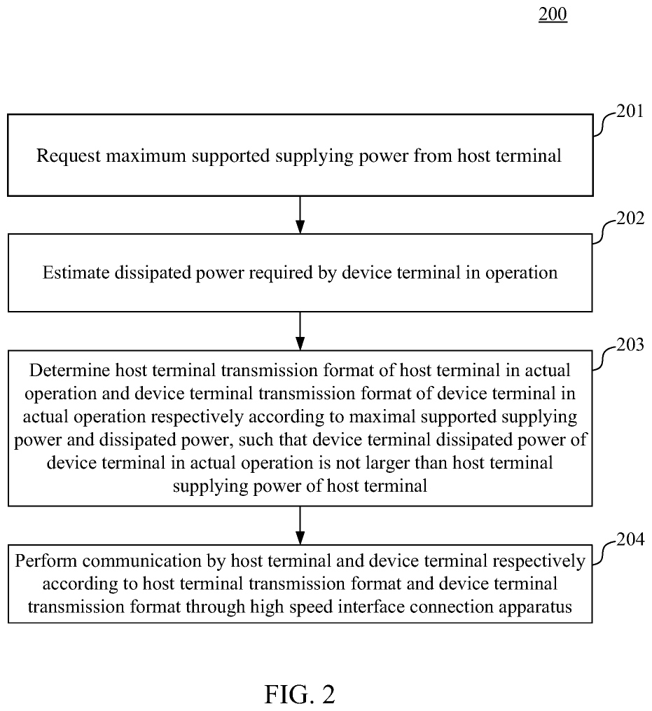

Reference is now made to FIG. 2. FIG. 2 is a flow chart of a high speed interface connection method 200 in an embodiment of the present invention. The high speed interface connection method 200 can be used in the high speed interface connection apparatus 14 illustrated in FIG. 1. More specifically, the high speed interface connection method 200 is performed when the processing circuit 146 executes the computer executable commands 141 to accomplish the function of the high speed interface connection apparatus 14.

The high speed interface connection method 200 includes the steps outlined below (The steps are not recited in the sequence in which the steps are performed. That is, unless the sequence of the steps is expressly indicated, the sequence of the steps is interchangeable, and all or part of the steps may be simultaneously, partially simultaneously, or sequentially performed).

In step 201, a maximum supported supplying power is requested from the host terminal 10.

As described above, a first port 140 is disposed at a terminal of the high speed interface connection apparatus 14. As a result, the high speed interface connection apparatus 14 can send request to the host terminal 10 through the interface at the first port 140 such that the host terminal 10 can transmit the maximum supported supplying power back to the high speed interface connection apparatus 14.

In step 202, a dissipated power required by the device terminal 12 in operation is estimated.

In an embodiment, the high speed interface connection apparatus 14 can request the dissipated power from the device terminal 12. As described above, a second port 142 is disposed at a terminal of the high speed interface connection apparatus 14. As a result, the high speed interface connection apparatus 14 can send request to the device terminal 12 through the interface at the second port 142 such that the device terminal 12 can transmit the dissipated power back to the high speed interface connection apparatus 14. In another embodiment, the high speed interface connection apparatus 14 can also calculate the dissipated power required by the device terminal 12 in operation by using the internal processing circuit 146.

In an embodiment, the dissipated power required by the device terminal 12 in operation substantially includes a first power required by the device terminal 12 in actual operation and a second power required by the high speed interface connection apparatus 14 in actual operation. As a result, the processing circuit 146 needs to add the two powers to obtain the dissipated power required by the device terminal 12.

In step 203, a host terminal transmission format of the host terminal 10 in actual operation and a device terminal transmission format of the device terminal 12 in actual operation are respectively determined according to the maximum supported supplying power and the dissipated power, such that the device terminal dissipated power of the device terminal 12 in actual operation is not larger than the host terminal supplying power of the host terminal 10 in actual operation.

In step 204, communication is performed by the host terminal 10 and the device terminal 12 respectively according to the host terminal transmission format and the device terminal transmission format through the high speed interface connection apparatus 14.

In an embodiment, the host terminal 10 corresponds to the first connection interface 100 and has a plurality of host terminal supported transmission formats. Take universal serial bus as an example, the host terminal supported transmission formats supported by the host terminal 10 include such as, but not limited to USB2.0, USB3.1 Gen1 and USB3.1 Gen2. USB2.0 has a transmission speed of 480 Mbps (equivalent to 60 MB/s). USB3.1 Gen1 has a transmission speed of 5 Gbps (equivalent to 640 MB/s). USB3.1 Gen2 has a transmission speed of 10 Gbps (equivalent to 1280 MB/s).

In an embodiment, the device terminal 12 corresponds to the second connection interface 120 and has a plurality of device terminal supported transmission formats.

Take serial advanced technology attachment as an example, the device terminal supported transmission formats supported by the device terminal 12 include such as, but not limited to SATA1.0, SATA2.0 and SATA3.0. SATA1.0 has a transmission speed of 1.5 Gbps (150 MB/s). SATA2.0 has a transmission speed of 3 Gbps (300 MB/s). SATA3.0 has a transmission speed of 6 Gbps (600 MB/s).

In another embodiment, take Peripheral Component Interconnect Express as an example, the device terminal supported transmission formats supported by the device terminal 12 include such as, but not limited to PCIE1.0, PCIE2.0 and PCIE3.0. PCIE1.0 has a transmission speed of 2.5 GT/s (250 MB/s). PCIE2.0 has a transmission speed of 5 GT/s (500 MB/s). PCIE3.0 has a transmission speed of 8 GT/s (984.6 MB/s).

In an embodiment, the host terminal supported transmission formats that the host terminal 10 has correspond to different host terminal transmission speeds. The device terminal supported transmission formats that the device terminal 12 has correspond to different device terminal transmission speeds and device terminal dissipated powers.

As a result, under the condition that the device terminal dissipated power is not larger than the host terminal supplying power, the processing circuit 146 can select one of the host terminal supported transmission formats as the transmission format of the host terminal 10 in actual operation and select one of the device terminal supported transmission formats as the transmission format of the device terminal 12 in actual operation.

In an embodiment, under the condition that the device terminal dissipated power is not larger than the host terminal supplying power, the device terminal transmission format has the device terminal transmission speed that is closest to the host terminal transmission speed.

For instance, in a numerical example, the maximum supported supplying power requested from the host terminal 10 in step 201 is 7.5 watts. The powers required for operating the device terminal 12 and the high speed interface connection apparatus 14 are 7 watts and 1 watt, which is 8 watts totally.

When the first connection interface 100 of the host terminal 10 is universal serial bus and the second connection interface 120 of the device terminal 12 is serial advanced technology attachment, though the format supported by the host terminal 10 having the highest speed is USB3.1 Gent and the format supported by the device terminal 12 having the highest speed is SATA3.0, the host terminal 10 can not afford the power dissipated by the device terminal 12 under such speeds. As a result, under the processing of the high speed interface connection apparatus 14, SATA2.0 having a lower speed (300 MB/s) is determined to be used as the device terminal transmission format in actual operation.

However, in order to keep the difference of the transmission speed between the host terminal 10 and the device terminal 12 within a reasonable range, USB3.1 Gen1 having a lower speed (640 MB/s) is selected by the high speed interface connection apparatus 14 as the host terminal transmission format used by the host terminal 10 in actual operation.

On the other hand, when the first connection interface 100 of the host terminal 10 is universal serial bus and the second connection interface 120 of the device terminal 12 is Peripheral Component Interconnect Express, though the format supported by the host terminal 10 having the highest speed is USB3.1 Gen2 and the format supported by the device terminal 12 having the highest speed is PCIE3.0, the host terminal 10 can not afford the power dissipated by the device terminal 12 under such speeds. As a result, under the processing of the high speed interface connection apparatus 14, PCIE2.0 having a lower speed (500 MB/s) is determined to be used as the device terminal transmission format in actual operation.

Under such a condition, since the format of the host terminal 10 having the highest transmission speed can handle the transmission speed of the selected device terminal transmission speed, USB3.1 Gen2 (1280 MB/s) is still selected by the high speed interface connection apparatus 14 as the host terminal transmission format of the host terminal 10 used by the host terminal 10 in actual operation.

In another embodiment, the host terminal supported transmission formats that the host terminal 10 has correspond to different host terminal transmission speeds. The device terminal 12 can support such as, but not limited to the function of Non-Volatile Memory express (NVMe). As a result, the device terminal supported transmission formats that the device terminal 12 has correspond to different device dissipated powers under the same device terminal transmission speed.

As a result, under the condition that the device terminal dissipated power is not larger than the host terminal supplying power, the processing circuit 146 can select one of the host terminal supported transmission formats as the transmission format used by the host terminal 10 in actual operation and select one of the device terminal supported transmission formats as the transmission format used by the device terminal 12 in actual operation.

For instance, in a numerical example, the maximum supported supplying power requested from the host terminal 10 in step 201 is 4.5 watts. Under the same transmission speed (e.g. the speed of SATA 3.0), the device terminal 12 supports four power status: PS0 corresponding to 5 watts, PS1 corresponding to 3 watts, PS2 corresponding to 1.5 watts and PS3 corresponding to 100 milliwatts.

Under such a condition, by using the management mechanism defined by NVMe, the device terminal 12 can be set to the suitable power status, while the transmission speeds of the host terminal 10 and the device terminal 12 can be set to the highest speeds supported by the host terminal 10 and the device terminal 12 respectively.

The high speed interface connection apparatus 14 and the high speed interface connection method 200 of the present invention can take the power supplying ability of the host terminal 10 into consideration to determine the transmission formats of the host terminal 10 and the device terminal 12 in actual operation. The data error or data damage caused due to the incapability of the host terminal 10 to support the dissipated power of the device terminal 12 under high speed operation can be avoided. As a result, the operation of the device terminal 12 can be guaranteed to be normal and the power-saving mechanism can be accomplished.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A high speed interface connection method capable for use in a high speed interface connection apparatus capable for electrically coupling a host terminal having a first connection interface and a device terminal having a second connection interface, the high speed interface connection method comprising:
requesting a maximum supported supplying power from the host terminal;
estimating a dissipated power required by the device terminal in operation;
respectively determining a host terminal transmission format of the host terminal in actual operation and a device terminal transmission format of the device terminal in actual operation according to the maximum supported supplying power and the dissipated power, such that a device terminal dissipated power of the device terminal in actual operation is not larger than a host terminal supplying power of the host terminal in actual operation; and
performing communication by the host terminal and the device terminal respectively according to the host terminal transmission format and the device terminal transmission format.

2. The high speed interface connection method of claim 1, wherein the dissipated power substantially comprises a first power required by the device terminal in actual operation and a second power required by the high speed interface connection apparatus in actual operation.

3. The high speed interface connection method of claim 1, wherein the host terminal transmission format is one of a plurality of host terminal supported transmission formats of the host terminal and the device terminal transmission format is one of a plurality of device terminal supported transmission formats of the device terminal, in which the host terminal transmission format has a host terminal transmission speed and the device terminal transmission format has a device terminal transmission speed that is closest to the host terminal transmission speed under a condition that the device terminal dissipated power is not larger than the host terminal supplying power.

4. The high speed interface connection method of claim 3, wherein each of the plurality of device terminal supported transmission formats corresponds to a different one of the device terminal transmission speed and a different one of the device dissipated power.

5. The high speed interface connection method of claim 3, wherein each of the plurality of device terminal supported transmission formats corresponds to different one of the device dissipated powers under the same device terminal transmission speed.

6. The high speed interface connection method of claim 1, wherein the first connection interface is universal serial bus (USB), and the second connection interface is serial advanced technology attachment (SATA) or Peripheral Component Interconnect Express (PCIE).

7. A high speed interface connection apparatus capable for electrically coupling a host terminal having a first connection interface and a device terminal having a second connection interface, the high speed interface connection apparatus comprising:
a first port configured to electrically couple to and communicate with the first connection interface;
a second port configured to electrically couple to and communicate with the second connection interface;
a storage configured to store a plurality of computer executable commands; and
a processing circuit electrically coupled to the first port, the second port and the storage and configured to retrieve the computer executable commands such that a high speed interface connection method is performed when the processing circuit executes the computer executable commands, wherein the high speed interface connection method comprises:
requesting a maximum supported supplying power from the host terminal;
estimating a dissipated power required by the device terminal in operation;
respectively determining a host terminal transmission format of the host terminal in actual operation and a device terminal transmission format of the device terminal in actual operation according to the maximum supported supplying power and the dissipated power, such that a device terminal dissipated power of the device terminal in actual operation is not larger than a host terminal supplying power of the host terminal in actual operation; and
performing communication by the host terminal and the device terminal respectively according to the host terminal transmission format and the device terminal transmission format.

8. The high speed interface connection apparatus of claim 7, wherein the dissipated power substantially comprises a first power required by the device terminal in actual operation and a second power required by the high speed interface connection apparatus in actual operation.

9. The high speed interface connection apparatus of claim 7, wherein the host terminal transmission format is one of a plurality of host terminal supported transmission formats of the host terminal and the device terminal transmission format is one of a plurality of device terminal supported transmission formats of the device terminal, in which the host terminal transmission format has a host terminal transmission speed and the device terminal transmission format has a device terminal transmission speed that is closest to the host terminal transmission speed under a condition that the device terminal dissipated power is not larger than the host terminal supplying power.

10. The high speed interface connection apparatus of claim 9, wherein each of the plurality of device terminal supported transmission formats corresponds to a different one of the device terminal transmission speed and a different one of the device dissipated power.

11. The high speed interface connection apparatus of claim 9, wherein each of the plurality of device terminal supported transmission formats corresponds to different one of the device dissipated powers under the same device terminal transmission speed.

12. The high speed interface connection apparatus of claim 7, wherein the first connection interface is universal serial bus (USB), and the second connection interface is serial advanced technology attachment (SATA) or Peripheral Component Interconnect Express (PCIE).
